(19) United States
(12) Patent Application Publication
(10) Pub. No.: US 2025/0384105 A1
(43) Pub. Date: Dec. 18, 2025

(54) SYSTEM AND METHOD FOR ARBITRARY-ORDER SENSITIVITY ANALYSIS OF THE MODALRESPONSE IN STRUCTURAL SYSTEMS

(71) Applicant: Board of Regents, The University of Texas System, Austin, TX (US)

(72) Inventors: Juan C. Velasquez-Gonzalez, San Antonio, TX (US); Juan David Navarro, San Antonio, TX (US); Mauricio Aristizabal Cano, San Antonio, TX (US); Harry R. Millwater, San Antonio, TX (US); Arturo Montoya, San Antonio, TX (US); David Restrepo, San Antonio, TX (US)

(21) Appl. No.: 19/238,364

(22) Filed: Jun. 14, 2025

Related U.S. Application Data
(60) Provisional application No. 63/660,186, filed on Jun. 14, 2024.

(51) Int. Cl. G06F 17/11

(52) U.S. Cl. CPC G06F 17/11

(57) ABSTRACT

A method for determining the arbitrary-order sensitivities of eigenvalues and eigenvectors of a structural system includes the steps of receiving data related to the structural system including model parameters {α₁, . . . , αⱼ} of the structural system and a maximum order of the derivative m to be computed, computing system matrices [K] and [M] and their partial derivatives, solving real-value generalized eigenvalue problem, determining sensitivities for the eigenvalues and the eigenvectors, and presenting an output of the sensitivities for the eigenvalues and the eigenvectors.

### RELATED APPLICATIONS

This application claims priority to U.S. Provisional application 63/660,186 filed Jun. 14, 2024 which is incorporated herein by reference in its entirety.

### FIELD

The present disclosure relates generally to applications of solving and analyzing eigenfrequency problems, and more particularly to systems and methods capable of arbitrary-order sensitivity analysis of the modal response in structural systems.

### BACKGROUND

Eigenfrequency problems involve determining the natural frequencies (eigenfrequencies) and corresponding mode shapes (eigenvectors) of a system. Natural frequencies are the specific frequencies at which a system tends to oscillate in the absence of external forces or damping. Each natural frequency corresponds to a mode of vibration. Mode shapes describe the deformation patterns of the system at each natural frequency. These shapes are essentially the eigenvectors of the system. The eigenfrequency problems are fundamental in various fields of engineering and physics, especially in the analysis of mechanical structures, acoustics, and vibrations.

### BRIEF DESCRIPTION OF THE DRAWINGS

FIG. 1A is a simplified flowchart of the methodology used to determine arbitrary-order sensitivities of the eigenvalues and eigenvectors of structural systems using HYPAD according to the teachings of the present disclosure;

FIGS. 1B-1E are equations used in the methodology used to determine arbitrary-order sensitivities of the eigenvalues and eigenvectors of structural systems using HYPAD according to the teachings of the present disclosure;

FIGS. 2A and 2B are flowcharts of Stage 1 and Stage 3, respectively, of the methodology to determine arbitrary-order sensitivities of the eigenvalues and eigenvectors of structural systems using HYPAD according to the teachings of the present disclosure;

FIG. 3A is a schematic representation of the hypercomplex masses and spring system serving as an example application of the methodology to determine arbitrary-order sensitivities of the eigenvalues and eigenvectors of structural systems using HYPAD according to the teachings of the present disclosure;

FIG. 3B show a schematic representation of the different axes of the mutidual representation of the mass-spring discrete model serving as an example application of the methodology to determine arbitrary-order sensitivities of the eigenvalues and eigenvectors of structural systems using HYPAD according to the teachings of the present disclosure;

FIG. 4 show equations that constitute the output of Stage 1 of the methodology to determine arbitrary-order sensitivities of the eigenvalues and eigenvectors of structural systems using HYPAD according to the teachings of the present disclosure;

FIG. 5A is a schematic of the cantilever beam for the free vibration system serving as an example application of the methodology to determine arbitrary-order sensitivities of the eigenvalues and eigenvectors of structural systems using HYPAD according to the teachings of the present disclosure;

FIG. 5B is a schematic representation of the finite element formulation for standard Euler-Bernoulli elements of the cantilever beam serving as an example application of the methodology to determine arbitrary-order sensitivities of the eigenvalues and eigenvectors of structural systems using HYPAD according to the teachings of the present disclosure;

FIG. 6A is a table of natural frequencies of the first six modes for a cantilever beam with a rectangular cross-sectional area (distinct eigenvalues);

FIG. 6B is a plot that shows the natural shape modes for a cantilever beam with a rectangular cross-sectional area (distinct eigenvalues), where a solid black line represents the analytical solution, a red line represents the first and second modes, a magenta line represents the third and fourth modes, and a green line represents the fifth and sixth modes;

FIG. 7A is a table showing the eigenvalue sensitivity of the cantilever beam example with respect to the density for a system with distinct eigenvalues;

FIG. 7B is a table showing the eigenvalue sensitivity of the cantilever beam example with respect to the beam length for a system with distinct eigenvalues;

FIG. 7C is a table showing the eigenvalue sensitivity of the cantilever beam example with respect to Young's Modulus and mixed partial derivatives for a system with distinct eigenvalues;

FIGS. 8A and 8B are plots showing Eigenvector sensitivities with respect to material properties and geometry parameters), where a solid black line represents the analytical solution, a red line represents the first and second modes, a magenta line represents the third and fourth modes, and a green line represents the fifth and sixth modes;

FIG. 9 is a plot showing the natural modes for a cantilever beam with a squared cross-sectional area (Repeated Eigenvalues), where a solid black line represents the analytical solution, a red line represents the first and second modes, a magenta line represents the third and fourth modes, and a green line represents the fifth and sixth modes;

FIG. 10 is a table showing the natural frequencies of the first six modes for a cantilever beam with a rectangular cross-sectional area (distinct eigenvalues);

FIG. 11A is a table showing the sensitivities for a system with repeated eigenvalues, where the subscripts imply derivation;

FIG. 11B is a table showing the mixed higher-order sensitivities for a system with repeated eigenvalues, where the subscripts imply derivation;

FIGS. 12A and 12B are plots showing eigenvector sensitivities with respect to the global geometric parameters, where a solid black line represents the analytical solution, a red line represents the first and second modes, a magenta line represents the third and fourth modes, and a green line represents the fifth and sixth modes;

FIG. 13 is a table of eigenvalue sensitivity to the width of the cross-sectional area for a system with repeated eigenvalues, where the subscripts imply derivation;

FIGS. 14A and 14B are plots showing eigenvector sensitivities with respect to directional geometric parameters, where a solid black line represents the analytical solution, a red line represents the first and second modes, a magenta line represents the third and fourth modes, and a green line represents the fifth and sixth modes;

FIGS. 15A-15C showing the first-order derivatives, second-order derivatives, and third order derivatives plots of step size refinement for the first mode of vibration, where the dashed line represents the results from HYPAD and the solid line the results from FD; and

FIG. 16 is a simplified block diagram of an operating environment for applications employing the methodology described herein to determine arbitrary-order sensitivities of the eigenvalues and eigenvectors of structural systems using HYPAD according to the teachings of the present disclosure.

### DETAILED DESCRIPTION

In structural design and analysis, it is important to determine the natural frequencies (eigenvalues) and mode shapes (eigenvectors) of structural systems because they provide insights into the systems' dynamic characteristics. These characteristics are assessed by solving the eigenfrequency problem and are highly affected by changes in the mechanical properties of the materials forming the structural system, the external loads, and the geometry of the models. The calculation of accurate arbitrary-order sensitivities of eigenvalues and eigenvectors is critical for structural analysis applications, including topology optimization, uncertainty quantification, system identification, finite element model updating, damage detection, and fault diagnosis. For these applications, most of the current methods used to obtain sensitivities for the eigenvalues and eigenvectors are restricted to first-order approximations. Although first-order approximations are adequate for most cases, when dealing with complex systems the magnitude of the modelling errors becomes substantial, leading to numerical issues. Further, current approaches to obtaining sensitivities for eigenvalues and eigenvectors lack generality, are complicated to implement, prone to numerical errors, and are computationally expensive.

The eigenvalues and eigenvectors of large complex structures are obtained by solving the generalized eigenvalue problem (GEP). In the GEP, the system's equation of motion is solved in the frequency domain, assuming a time-harmonic solution and a zero-loading condition. For the GEP, the eigenvalues and eigenvectors are calculated in different steps. For most structures, closed form solutions of the eigenvalues do not exist; therefore, these are found by using numerical methods, such as the QR method, Implicit Lanczos iteration, and the Davidson Method, among others. The eigenvectors are obtained algebraically by replacing the eigenvalues' numerical results into the equation of motion. As the GEP is solved numerically, this represents a major challenge when calculating higher order sensitivities in eigenfrequency problems. Different methods have been proposed to calculate the sensitivities for the eigenvalues and eigenvectors. Because these two are calculated in different steps, the methodologies have been developed independently from each other.

The present disclosure describes a methodology that uses hypercomplex automatic differentiation (HYPAD) and semi-analytical expressions to obtain arbitrary-order sensitivities for eigenfrequency problems. The new methodology described herein exhibits no sign of truncation nor subtractive cancellation errors regardless of the order of the sensitivity. The method integrates HYPAD with exact semi-analytical expressions developed from differentiating the equations of the generalized eigenvalue problem, and to compute arbitrary-order sensitivities of the structural matrices. In this approach both truncation and subtractive errors are eliminated from the sensitivity analysis, and a single general expression is used for the computation of the sensitivities of both eigenvalues and eigenvectors up to arbitrary-order. This results in accurate and efficient sensitivity results. The HYPAD method can calculate all higher-order sensitivities with respect to all the input model parameters using only one function evaluation, which makes it easy to implement in commercial practice. Regardless of the hypercomplex nature of the operations used to calculate the sensitivities, the method presented here uses real only numbers when solving the generalized eigenvalue problem. There are many applications for the methodology to determine higher-order sensitivity analysis in structural systems. As examples, the sensitivities can be used to improve the performance of topology optimization models, finite element updating algorithms, and other algorithms where accurate derivatives are crucial to correctly guide the processes.

The novel methodology described here uses a differentiation method for eigenvalues and eigenvectors that employs a single expression to accurately compute the machine precision sensitivities, regardless of the order of derivatives involved. HYPAD is formulated within a discrete continuum approach based on the Finite Element Method (FEM) to obtain highly accurate arbitrary-order sensitivities of the mass and stiffness matrices with respect to any input parameter. Then, this sensitivity information is linked with the expressions to calculate the sensitivities of eigenvalues and eigenvectors presented by Fox and Kapoor (Fox, R. L.; Kapoor, M. P. Rates of change of eigenvalues and eigenvectors. AIAA J. 1968, 6, 2426-2429). and Yang et al. (Yang, Q.; Peng, X. An exact method for calculating the eigenvector sensitivities. Appl. Sci. 2020, 10, 2577), which are numerically differentiated using HYPAD. It should be noted that although the method is presented using the FEM, it can be implemented using any discretization and spatial integration, such as the Boundary Element Method (BEM), isogeometric analysis (IGA), or the Spectral Finite Element Method (SFEM).

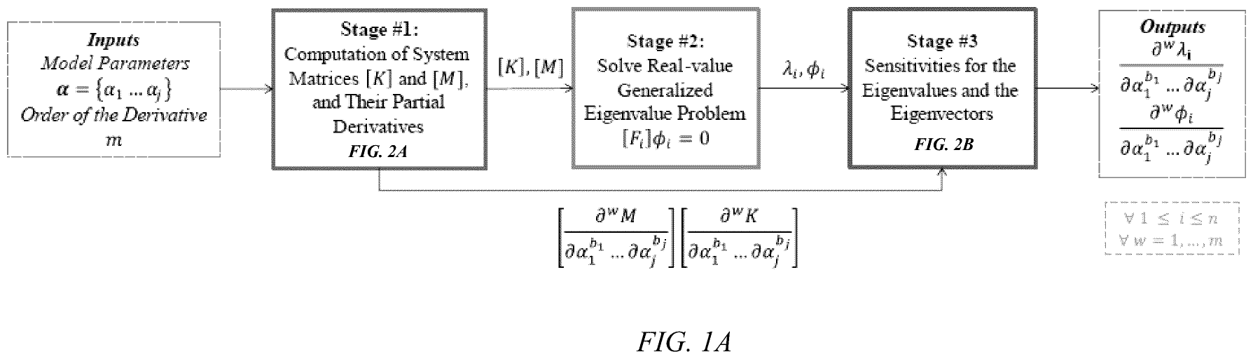

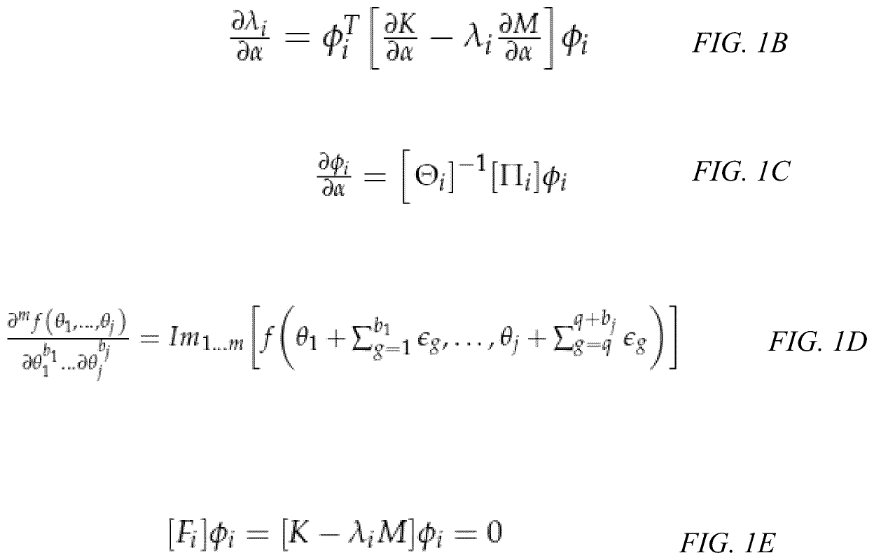

The methodology used to obtain arbitrary-order sensitivities of the eigenvalues and eigenvectors in eigenfrequency problems using HYPAD with multidual numbers is based on a process with three stages, as shown in the flowchart in FIG. 1A. The main inputs required to perform the sensitivities calculation process are the maximum order of the derivative m to be computed, and all the input parameters of the model={α₁, . . . , αⱼ}. In Stage 1, HYPAD is used to compute the system matrices [K] and [M], and their m^{th} order sensitivities with respect to any input model parameters. In Stage 2, the matrices [K] and [M] are used to solve the traditional real-valued GEP for structural systems. Finally, in Stage 3, the sensitivities of [K] and [M] obtained from Stage 1, e.g.,

$$[ {\partial }^{w} M / ( \partial {α}_{1}^{{b}_{1}} … \partial {α}_{j}^{{b}_{j}} ) ] and$$

$$[ {\partial }^{w} K / ( \partial {α}_{1}^{{b}_{1}} … \partial {α}_{j}^{{b}_{j}} ) ] ∀ w = 1 , … , m ) ,$$

and the eigenvalues and eigenvectors obtained from Stage 2, e.g., λⱼ and φᵢ, are provided to a recursive subroutine that uses HYPAD to systematically expand the two equations shown in FIGS. 1B and 1C to enable the computation of all the sensitivities of the eigenvalues and eigenvector up to order m.

Stage 1 of the methodology is shown in FIG. 1A, where the first step is to convert all the input parameters of the model into multidual variables of order m. Next, unitary perturbations, h, are added to the independent imaginary axes of the multidual axis of the specific variables for which the sensitivities want to be calculated. Adding perturbations to the same parameter in two different independent imaginary axes results in having second-order derivatives with respect to the perturbed parameter. Similarly, perturbing two different variables in two different independent imaginary axes results in crossed second-order derivatives. Following this logic, any combination of arbitrary-order sensitivities can be obtained following this methodology. With the design parameters represented as multidual numbers and the appropriate perturbations applied, the structural system is discretized to obtain the global mass and stiffness matrices. Regardless of the discretization and spatial integration method used (e.g., FEM, BEM, SFEM, or others), when any input design parameter is represented as multidual and consequently perturbed, the mass and stiffness matrices will result in two n×n multidual matrices [M]* and [K]*. This approach is non-intrusive because the discretization and integration algorithms are unchanged; however, as the variables are multidual, algebraic operations are conducted using MultiZ.

The next step in the methodology is to extract the real and imaginary information of [M]* and [K]* to form p+1 real matrices with dimensions n×n, with n being the number of DOF in the system, and p is the number of dual imaginary axes. Each matrix corresponds to an axis on [M]* and [K]*. The matrices obtained with the information from the real axes of [M]* and [K]*, correspond to the global [M] and [K] matrices for the system and are identical to those obtained from a traditional real-variable analysis; while the matrices formed with the imaginary axes (e.g., [K^{e}^{₁}], . . . , [K^{e}^{ₚ}], and [M^{e}^{₁}], . . . , [M^{e}^{ₚ}]) contain the information related to the partial derivatives of [M] and [K] with respect to the design input parameters that are perturbed. Finally, to complete the first stage, the derivatives of the system matrices are computed following the equation shown in FIG. 1D. At the end of the first stage all the outputs are real variables. The dual variables are not passed to subsequent steps to simplify the algorithm.

Stage 2 solves the real-value GEP shown in FIG. 1E to extract the system's eigenvalues (λᵢ) and right eigenvectors with mass normalization (φᵢ). Here, any generalized eigensolver for self-adjoint problems can be applied. This constitutes a major advantage of the method since no hypercomplex-valued solvers are required. In addition, only the specific number of eigenvalues i, ∀1≤i≤n desired needs to be computed, avoiding the calculation of the whole basis of eigenvalues in the systems. Moreover, any eigenvalue and eigenvector derivative corresponding to any arbitrary mode can be calculated.

Stage 3 includes a recursive algorithm controlled by the loop variable s that enables obtaining the required sensitivities in ascending order up to the desired order m using HYPAD. These recursive operations controlled by s are needed, because to obtain the sensitivities for order s+1 it is necessary to have solved the s-th order sensitivities for the eigenvalues and the eigenvectors. The first step in Stage 3 is to convert λᵢ, φᵢ, [M], [K], [∂M/∂α], and [∂K/∂α] into multidual variables of order s. This procedure allows the use of HYPAD to calculate the sensitivities. During the first iteration when s=0, the input parameters are converted into zero-order multidual numbers (i.e., multiduals of zero-order are real numbers). In subsequent iterations (i.e., s>0), each imaginary axis of the multidual number contains the partial derivatives of the variables with respect to the input parameters of the model. In the case of the variables [∂K/∂α]* and [∂M/∂α]* that are already first-order sensitivities, the real part corresponds to the first-order sensitivities (e.g., [∂K/∂α] and [∂M/∂α]), and the imaginary axes contain partial derivatives up to order s+1. In the case of λi* and φi*, the real part corresponds to the eigenvalues and eigenvectors, and the imaginary axes are built from their derivatives with respect to the specific variables of interest. Note that the sensitivities for λᵢ and φᵢ up to order s are always available because of the iterative nature of the procedure. Moreover, all combinations of partial derivatives of [K] and [M] are available from the first stage.

With the multidual arrays, the equation in FIG. 1B is evaluated, which results in a multidual variable (∂λᵢ/∂α)* that contains the first-order sensitivities in the real axis, and the s+1 order sensitivities in the dual imaginary axis. The expression evaluated at the multidual sampling points is:

$$\frac{\partial {λ}_{i}^{*}}{\partial α} = {ϕ}_{i}^{* T} [ [ \frac{\partial K}{\partial α} ] * - {λ}_{i}^{*} [ \frac{\partial M}{\partial α} ] * ] {ϕ}_{i}^{*}$$

Using the same multidual arrays, the equation shown in FIG. 1C is evaluated to calculate another multidual variable (∂φᵢ/∂α)*. As for the eigenvalues, this variable contains in the real part, the first-order sensitivities of the eigenvectors, and in the dual imaginary axes, the s+1 sensitivities. The expression evaluated at the multidual sampling points is:

$$\frac{\partial {ϕ}_{i}^{*}}{\partial α} = {[ Θ ]}^{* - 1} [ \prod ] * {ϕ}_{i}^{*}$$

At this point, the s+1 order sensitivities of the eigenvalues and the eigenvectors lie in the imaginary axes of (∂λi/∂α)* and (∂φi/∂α)* found in the previous two steps, respectively. Thus, to obtain the sensitivities, such coefficients are extracted by following the next rules. In the first iteration, when s=0, all the variables are multidual numbers of order zero (real numbers); therefore, this corresponds to a traditional first-order sensitivities calculation following the methodologies of Fox and Kapoor and Yang and Peng. In this case, the real part (Im₀[ ]) contains the sensitivity information. In subsequent iterations (s>0), the Im₁ . . . s[ ] is extracted, and the sensitivities are calculated by following the equation shown in FIG. 1D. To exemplify the specific axes that must be extracted on each pass through the loop, consider for instance the case of fourth-order sensitivities, the last iteration corresponds to s=3; therefore, the Im1 . . . 3[ ] should be extracted, which corresponds to the Im123[ ] axis of the multidual number. After completing the passes through the loop (s+1≥m), all the sensitivities up to the desired order m for any specific number of modes are available. In addition, all the lower-order mixed partial derivatives' combinations are computed in the same process.

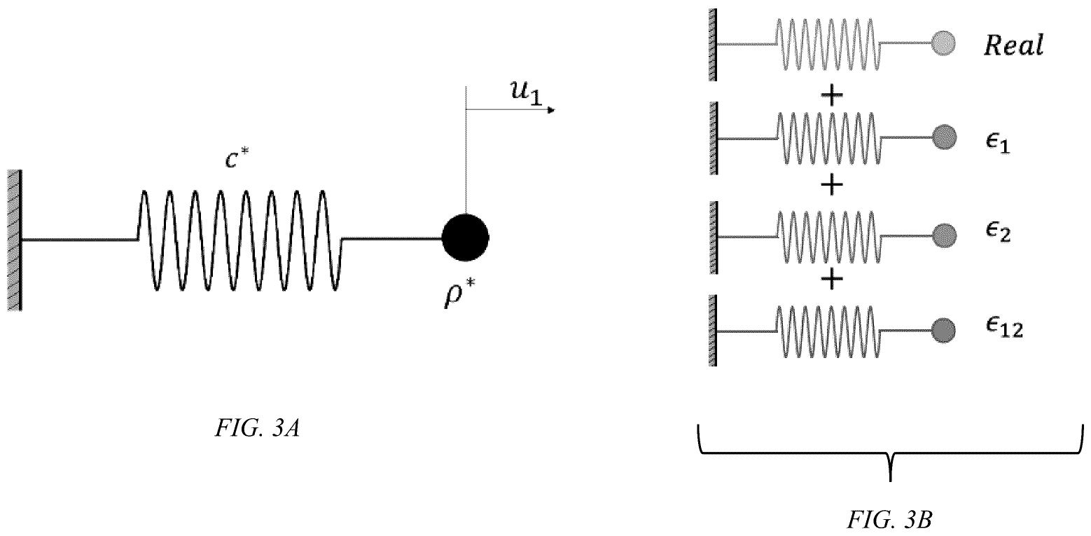

Two illustrative applications for solving the arbitrary-order sensitivities in eigenfrequency problems using HYPAD methodology are described below. The first application is the simple mass and spring system illustrated in FIG. 3A. The novel methodology is used to obtain the mixed second-order partial derivatives for the simple harmonic oscillator shown in FIG. 3A. The sensitivities are calculated with respect to the mass, ρ, and the spring stiffness, c. The inputs for the algorithm presented in FIG. 1A are the model parameters α={ρ, c}, and the order of the derivative, in this case second-order m=2.

In Stage 1, for the case of mixed second-order sensitivities, both variables ρ and c must be converted into multidual arrays. In this case, bi-dual numbers are used with p=3. Therefore, three imaginary axes (e.g., ϵ₁, ϵ₂, and ϵ₁₂) are required. A graphical representation of this procedure is shown in FIG. 3B. To calculate mixed second-order partial derivatives with respect to ρ and c, both variables are perturbed by applying a unitary step to the imaginary axes ϵ₁ and ϵλ, respectively:

$$ρ *= {ρ}^{Re} + 1 {ϵ}_{1} + 0 {ϵ}_{2} + 0 {ϵ}_{12}$$

$$c *= {c}^{Re} + 0 {ϵ}_{1} + 1 {ϵ}_{2} + 0 {ϵ}_{12}$$

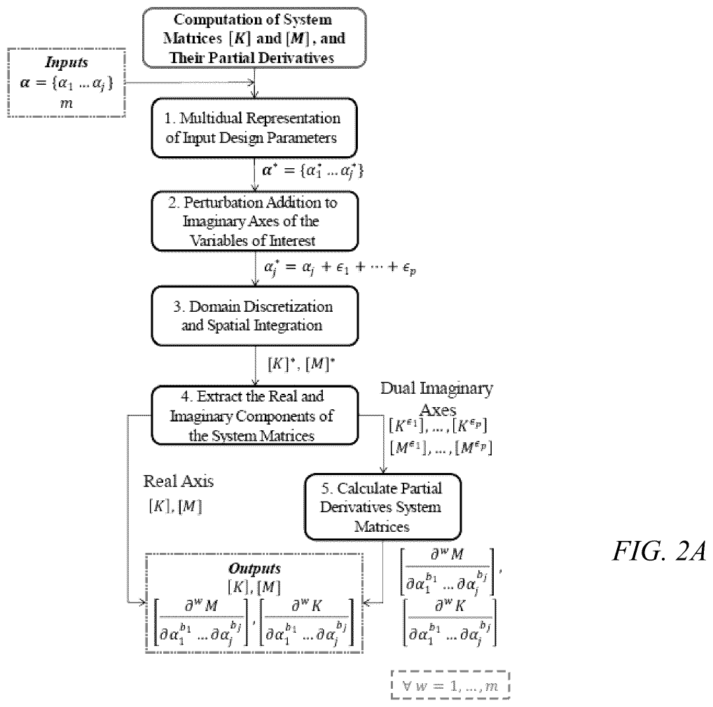

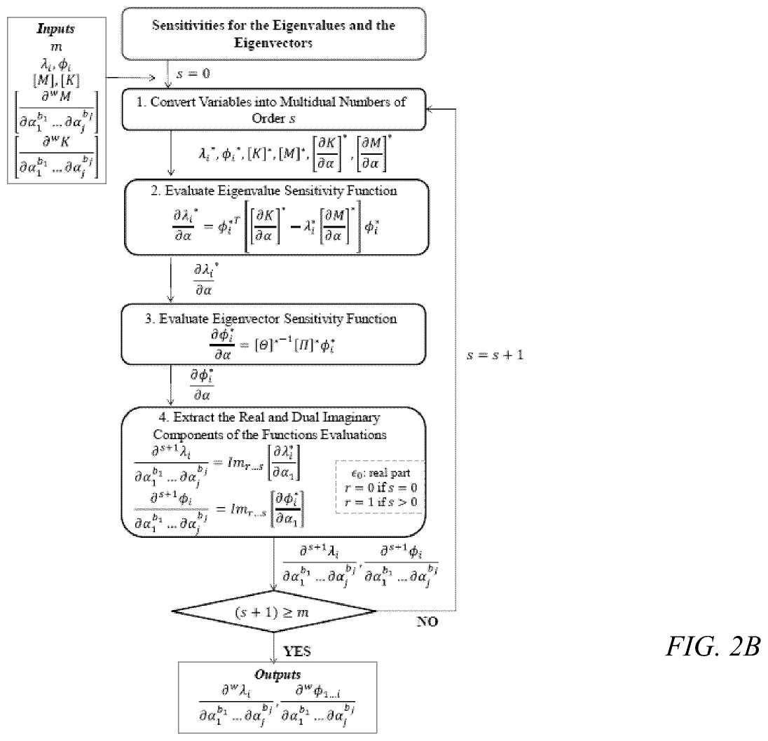

As this system corresponds to a one-degree of freedom problem, no domain discretization and spatial integrations is necessary. Following the conventions from FIGS. 2A and 2B, [M]*=ρ* and [K]*=c*. The real components of the multidual variables [M]* and [K]* are extracted to form the following arrays:

$$[ M ] = {Im}_{0} [ [ M ] * ] = Real [ [ M ] * ] = {ρ}^{Re}$$

$$[ K ] = {Im}_{0} [ [ K ] * ] = Real [ [ K ] * ] = {c}^{Re}$$

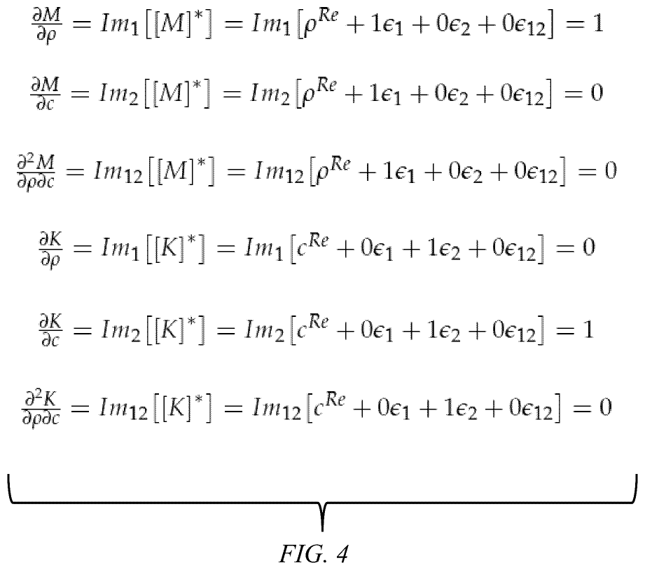

Similarly, the partial derivatives of M and K are obtained by evaluating the equation shown in FIG. 1D using the information from the p dual imaginary components of the multidual variables [M]* and [K]* as shown in FIG. 4. The equations shown in FIG. 4 are the output from Stage 1, which is passed to the subsequent stages to calculate the eigenvalues' and eigenvectors' sensitivities.

In Stage 2, using the variables from the [M] and [K] equations above, the following generalized eigenvalue problem is solved by: λ₁[ρ^{Re}][ϕ₁^{Re}]=[c^{RE}][ϕ₁^{Re}] where the eigenvalue and mass normalized eigenvector correspond to:

$${λ}_{1} = {c}^{Re} / {ρ}^{Re}$$

$${ϕ}_{1} = {( {ρ}^{Re} )}^{- 1 / 2}$$

In Stage 3, Iteration 1 (s=0), multidual numbers of order zero (real numbers) are employed, therefore, the input variables m=2, λ₁, φ₁, [M], [K], and the partial derivatives obtained in Stage 1 are kept as real numbers. The first-order sensitivities of the eigenvalues are obtained by evaluating the equation shown in FIG. 1B:

$$\frac{\partial {λ}_{1}}{\partial ρ} = {ϕ}_{1}^{T} [ \frac{\partial K}{\partial ρ} - {λ}_{1} \frac{\partial M}{\partial ρ} ] {ϕ}_{1} = - \frac{{c}^{Re}}{{( {ρ}^{Re} )}^{2}}$$

$$\frac{\partial {λ}_{1}}{\partial c} = {ϕ}_{1}^{T} [ \frac{\partial K}{\partial c} - {λ}_{1} \frac{\partial M}{\partial c} ] {ϕ}_{1} = - \frac{1}{( {ρ}^{Re} )}$$

Similarly, the first-order sensitivities for the eigenvectors are obtained by evaluating the equation shown in FIG. 1C:

$$\frac{\partial {ϕ}_{1}}{\partial ρ} = {[ [ K ] - {λ}_{1} [ M ] + {λ}_{1} {ϕ}_{1} {ϕ}_{1}^{T} [ M ] ]}^{- 1} [ \frac{\partial {λ}_{1}}{\partial ρ} [ M ] + {λ}_{1} [ \frac{\partial M}{\partial ρ} ] - [ \frac{\partial K}{\partial ρ} ] - \frac{1}{2} {ϕ}_{1}^{T} [ \frac{\partial M}{\partial ρ} ] - {ϕ}_{1} {λ}_{1} ] = - \frac{1}{2 ( {( {ρ}^{Re} )}^{3 / 2} )}$$

$$\frac{\partial {ϕ}_{1}}{\partial c} = {[ [ K ] - {λ}_{1} [ M ] + {λ}_{1} {ϕ}_{1} {ϕ}_{1}^{T} [ M ] ]}^{- 1} [ \frac{\partial {λ}_{1}}{\partial c} [ M ] + {λ}_{1} [ \frac{\partial M}{\partial c} ] - [ \frac{\partial K}{\partial c} ] - \frac{1}{2} {ϕ}_{1}^{T} [ \frac{\partial M}{\partial c} ] - {ϕ}_{1} {λ}_{1} ] = 0$$

In the second iteration, where s=1, the second-order sensitivities with respect to ρ and k are obtained. All variables are first converted into multidual numbers of order one:

$${λ}_{1}^{*} = {λ}_{1}^{Re} + \frac{\partial {λ}_{i}}{\partial c} {ϵ}_{1}$$

$${ϕ}_{1}^{*} = {ϕ}_{1}^{Re} + \frac{\partial {ϕ}_{1}}{\partial c} {ϵ}_{1}$$

$$[ M ] *= {ρ}^{Re} + \frac{\partial M}{\partial c} {ϵ}_{1}$$

$$[ K ] *= {c}^{Re} + \frac{\partial K}{\partial c} {ϵ}_{1}$$

$$[ \frac{\partial K}{\partial ρ} * ] = \frac{\partial K}{\partial ρ} + \frac{\partial K}{\partial ρ \partial c} {ϵ}_{1}$$

$$[ \frac{\partial M}{\partial ρ} * ] = \frac{\partial M}{\partial ρ} + \frac{\partial M}{\partial ρ \partial c} {ϵ}_{1}$$

The equation shown in FIG. 1B is evaluated with the multidual arrays from the above equations as follows:

$$\frac{\partial {λ}_{1}^{*}}{\partial ρ} = {( {ϕ}_{1}^{Re} + \frac{\partial {ϕ}_{1}}{\partial c} {ϵ}_{1} )}^{T} [ [ \frac{\partial K}{\partial ρ} + \frac{\partial K}{\partial ρ \partial c} {ϵ}_{1} ] - ( {λ}_{1}^{Re} + \frac{\partial {λ}_{1}}{\partial c} {ϵ}_{1} ) [ \frac{\partial M}{\partial ρ} + \frac{\partial M}{\partial ρ \partial c} {ϵ}_{1} ] ] ( {ϕ}_{1}^{Re} + \frac{\partial {ϕ}_{1}}{\partial c} {ϵ}_{1} ) \frac{\partial {λ}_{1}^{*}}{\partial ρ} = - \frac{k}{{( {ρ}^{Re} )}^{2}} - \frac{1}{{( {ρ}^{Re} )}^{2}} {ϵ}_{1}$$

Similarly, to calculate the second-order sensitivities of the eigenvectors, the equation shown in FIG. 1C is evaluated as:

$$\frac{\partial {ϕ}_{1}^{*}}{\partial ρ} = {[ Θ ]}^{* - 1} [ \prod ] * {ϕ}_{i}^{*}$$

$$\frac{\partial {ϕ}_{1}^{*}}{\partial ρ} = - \frac{1}{2 ( {( {ρ}^{Re} )}^{3 / 2} )} + 0 {ϵ}_{1}$$

The second-order sensitivity of the eigenvalue and the eigenvector is calculated by extracting the information from axis €₁ in the above equations as:

$$\frac{{\partial }^{2} {λ}_{1}}{\partial ρ \partial c} = - \frac{1}{{( {ρ}^{Re} )}^{2}}$$

$$\frac{{\partial }^{2} {ϕ}_{1}}{\partial ρ \partial c} = 0$$

Since the variable s is exhausted, the stopping criteria is met, and the end of the algorithm is reached. Note that the expressions in the above equations contain, in the real axis, the information from the first-order sensitivity, which means that the arrays obtained at the end of the procedure in FIG. 3B contain the arbitrary-order sensitivities and all the lower-order sensitivities.

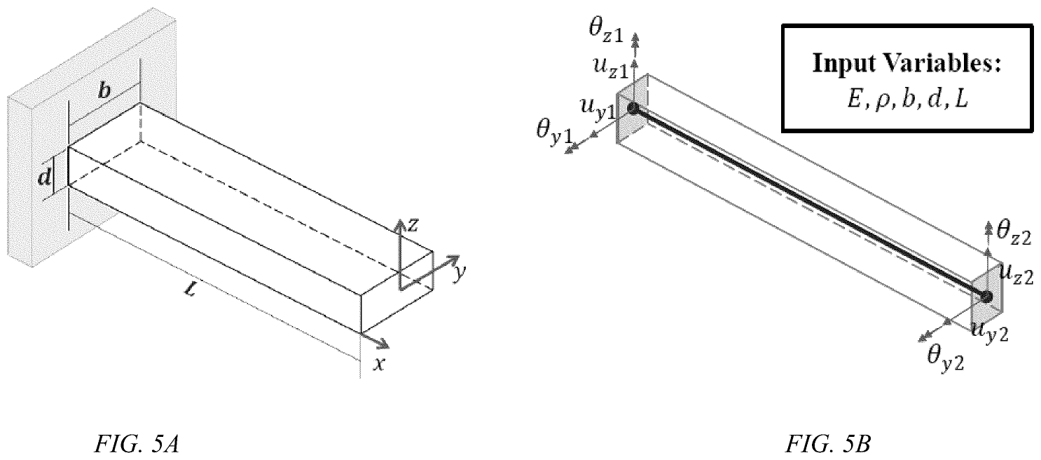

The second example application of demonstrating the methodology is applied to the analysis of the free vibration of a uniform elastic cantilever beam, as shown in FIG. 5A. The beam has a length L, stiffness E, mass density ρ, and a constant rectangular cross-sectional area A with width b, and height d. The analytical expressions for the natural frequencies and shapes of the free vibration modes correspond to:

$${λ}_{i} = \{ \begin{matrix}{λ}_{iy} & = {γ}_{i}^{4} \frac{{EI}_{y}}{ρ {AL}^{4}} \\ {λ}_{iz} & = {γ}_{i}^{4} \frac{{EI}_{z}}{ρ {AL}^{4}}\end{matrix} where {I}_{y} = \frac{{bd}^{3}}{12} , {I}_{z} = \frac{{bd}^{3}}{12} , A = bd$$

$${ϕ}_{i} ( x ) = \frac{1}{\sqrt{ρ AL}} [ \frac{( sinh ( {γ}_{i} ) + sin ( {γ}_{i} ) ) \{ cosh ( \frac{{γ}_{i} x}{L} ) - cos ( \frac{{γ}_{i} x}{L} ) \}}{sinh ( {γ}_{i} ) + sin ( {γ}_{i} )} - \frac{( cosh ( {γ}_{i} ) + cos ( {γ}_{i} ) ) \{ sinh ( \frac{{γ}_{i} x}{L} ) - sin ( \frac{{γ}_{i} x}{L} ) \}}{sinh ( {γ}_{i} ) + sin ( {γ}_{i} )} ]$$

Where γᵢ are given by:

$$cosh ( {γ}_{i} ) + cos ( {γ}_{i} ) + 1 = 0 ∀ ( i = 1 , 2 , … )$$

The three first roots of this equation are: γ₁=1.8751 γ₂=4.6941 γ₃=7.8547. Since the beam has two axes of symmetry (i.e., y and z), the eigenvalues will appear alternated in the analytical solution. Therefore, the modes will be classified between those in the y-direction as λ_{iy}, and those in the z-direction as λ_{iz}. The system can have repeated or distinct eigenvalues depending on the characteristics of the cross-sectional area. The first case of repeated eigenvalues is evident in symmetric cross-sections when the cross-section has the same first moment of area with respect to two or more axes. For instance, for a square cross-section, the inertia in directions y and z are the same; therefore, λ_{iy}=λ_{iz}. On the contrary, if a non-symmetric cross-section is used, as in the case of a rectangle cross-section, the inertia in y and z are different; therefore, λ_{iy}≠λ_{iz}. Here, both situations are considered.

The methodology can be implemented in FORTRAN using the LAPACK library to solve the GEP and to obtain the eigenvectors with mass normalization using the procedure shown in FIG. 1A. As an initial step, the parameters of the model (E, ρ, L, b and d) are transformed into their corresponding multidual representation to become E*, ρ*, L*, b* and d*, depending on the derivatives calculated in each case. Subsequently, unit perturbations are added along the different multidual imaginary axes of the variables depending on the specific sensitivities that are to be calculated. The beam is discretized using standard Euler-Bernoulli elements, with each node containing four DOF, two translational and two rotational, as shown in FIG. 5B. A total of one hundred equal-length Euler-Bernoulli elements are used. The element stiffness [K^{e}]* and mass [M^{e}]* matrices are calculated by using the multidual variables and the formulation in the equations below, respectively. In addition, the global mass and stiffness matrices are assembled following a traditional finite element method scheme.

$$[ {K}^{e} ] *= \frac{E *}{L *} [ \begin{matrix}\frac{12 {I}_{z}^{*}}{{L}^{* 2}} & 0 & 0 & \frac{6 {I}_{z}^{*}}{{L}^{* 2}} & - \frac{12 {I}_{z}^{*}}{{L}^{* 2}} & 0 & 0 & \frac{6 {I}_{z}^{*}}{{L}^{*}} \\ 0 & \frac{12 {I}_{y}^{*}}{{L}^{* 2}} & - \frac{6 {I}_{y}^{*}}{{L}^{*}} & 0 & 0 & - \frac{12 {I}_{y}^{*}}{{L}^{* 2}} & - \frac{6 {I}_{y}^{*}}{{L}^{*}} & 0 \\ 0 & - \frac{6 {I}_{y}^{*}}{{L}^{*}} & 4 {I}_{y}^{*} & 0 & 0 & \frac{6 {I}_{y}^{*}}{{L}^{*}} & 2 {I}_{y}^{*} & 0 \\ \frac{6 {I}_{z}^{*}}{{L}^{*}} & 0 & 0 & 4 {I}_{z}^{*} & - \frac{6 {I}_{z}^{*}}{{L}^{*}} & 0 & 0 & 2 {I}_{z}^{*} \\ - \frac{12 {I}_{z}^{*}}{{L}^{* 2}} & 0 & 0 & - \frac{6 {I}_{z}^{*}}{{L}^{*}} & \frac{12 {I}_{z}^{*}}{{L}^{* 2}} & 0 & 0 & - \frac{6 {I}_{z}^{*}}{{L}^{*}} \\ 0 & - \frac{12 {I}_{y}^{*}}{{L}^{* 2}} & \frac{6 {I}_{y}^{*}}{{L}^{*}} & 0 & 0 & \frac{12 {I}_{y}^{*}}{{L}^{* 2}} & \frac{6 {I}_{y}^{*}}{{L}^{*}} & 0 \\ 0 & - \frac{6 {I}_{y}^{*}}{{L}^{*}} & 2 {I}_{y}^{*} & 0 & 0 & \frac{6 {I}_{y}^{*}}{{L}^{*}} & 4 {I}_{y}^{*} & 0 \\ \frac{6 {I}_{z}^{*}}{{L}^{*}} & 0 & 0 & 2 {I}_{z}^{*} & - \frac{6 {I}_{z}^{*}}{{L}^{*}} & 0 & 0 & 4 {I}_{z}^{*}\end{matrix} ]$$

$$where {I}_{z}^{*} = d * {b}^{* 3} / 12 , and {I}_{y}^{*} = {d}^{* 3} b * / 12.$$

$$[ {M}^{e} ] *= \frac{ρ * A * L *}{420} [ \begin{matrix}156 & 0 & 0 & 22 {L}^{*} & 54 & 0 & 0 & - 13 {L}^{*} \\ 0 & 156 & - 22 {L}^{*} & 0 & 0 & 54 & 13 {L}^{*} & 0 \\ 0 & - 22 {L}^{*} & 4 {L}^{* 2} & 0 & 0 & - 13 {L}^{*} & - 3 {L}^{* 2} & 0 \\ 22 {L}^{*} & 0 & 0 & 4 {L}^{* 2} & 13 {L}^{*} & 0 & 0 & - 3 {L}^{* 2} \\ 54 & 0 & 0 & 13 {L}^{*} & 156 & 0 & 0 & - 22 {L}^{*} \\ 0 & 54 & - 13 {L}^{*} & 0 & 0 & 156 & 22 {L}^{*} & 0 \\ 0 & 13 {L}^{*} & - 3 {L}^{* 2} & 0 & 0 & 22 {L}^{*} & 4 {L}^{* 2} & 0 \\ - 13 {L}^{*} & 0 & 0 & - 3 {L}^{* 2} & - 22 {L}^{*} & 0 & 0 & 4 {L}^{* 2}\end{matrix} ]$$

$$Where A *= d * b * .$$

Subsequently, the boundary conditions are defined for the multidual matrices [K]* and [M]*, eliminating the real and dual imaginary DOF under homogeneous Dirichlet boundary conditions. Then, the information from each imaginary axis of the multidual arrays was extracted to form p=7 matrices corresponding to each of the dual imaginary axes of the tridual number. The matrices [K] and [M] constructed from the information of the real axis are used to solve the GEP and obtain the eigenvalues and eigenvectors. In addition, the information from the dual imaginary axes was used to calculate the partial derivatives of the system matrices by following the equation in FIG. 1D. Then, as described in FIG. 2B, the eigenvalues λᵢ, the eigenvectors φᵢ for i=1, . . . , 6, m=3, the system matrices [K] and [M], and their partial derivatives, are used to calculate the sensitivities of the eigenvalues and eigenvectors. Three iterations are processed in Stage 3.

The relative percentage error (RE) described in this equation,

$$RE = \frac{\vert {y}_{j}^{Analytical} - {y}_{j}^{ZTSE} \vert}{\vert {y}_{j}^{Analytical} \vert}$$

is used to measure the error for each of the eigenvalues and their sensitivities. For the eigenvectors, an average of the RE was used as an error measurement. For both measures of error, the analytical solutions in these equations below are used as a reference.

$${λ}_{i} = \{ \begin{matrix}{λ}_{iy} & = {γ}_{i}^{4} \frac{{EI}_{y}}{ρ {AL}^{4}} \\ {λ}_{iz} & = {γ}_{i}^{4} \frac{{EI}_{z}}{ρ {AL}^{4}}\end{matrix} where {I}_{y} = \frac{{bd}^{3}}{12} , {I}_{z} = \frac{{bd}^{3}}{12} , A = bd$$

$${ϕ}_{i} ( x ) = \frac{1}{\sqrt{ρ AL}} [ \frac{( sinh ( {γ}_{i} ) + sin ( {γ}_{i} ) ) \{ cosh ( \frac{{γ}_{i} x}{L} ) - cos ( \frac{{γ}_{i} x}{L} ) \}}{sinh ( {γ}_{i} ) + sin ( {γ}_{i} )} - \frac{( cosh ( {γ}_{i} ) + cos ( {γ}_{i} ) ) \{ sinh ( \frac{{γ}_{i} x}{L} ) - sin ( \frac{{γ}_{i} x}{L} ) \}}{sinh ( {γ}_{i} ) + sin ( {γ}_{i} )} ]$$

A semi-analytical demonstration was conducted to illustrate the present verification problem for the reader. In this case, the cantilever beam was discretized using a single Euler-Bernoulli element. Although such a small number of elements does not achieve convergence and the stability of the results, it shows a step-by-step demonstration of the methodology.

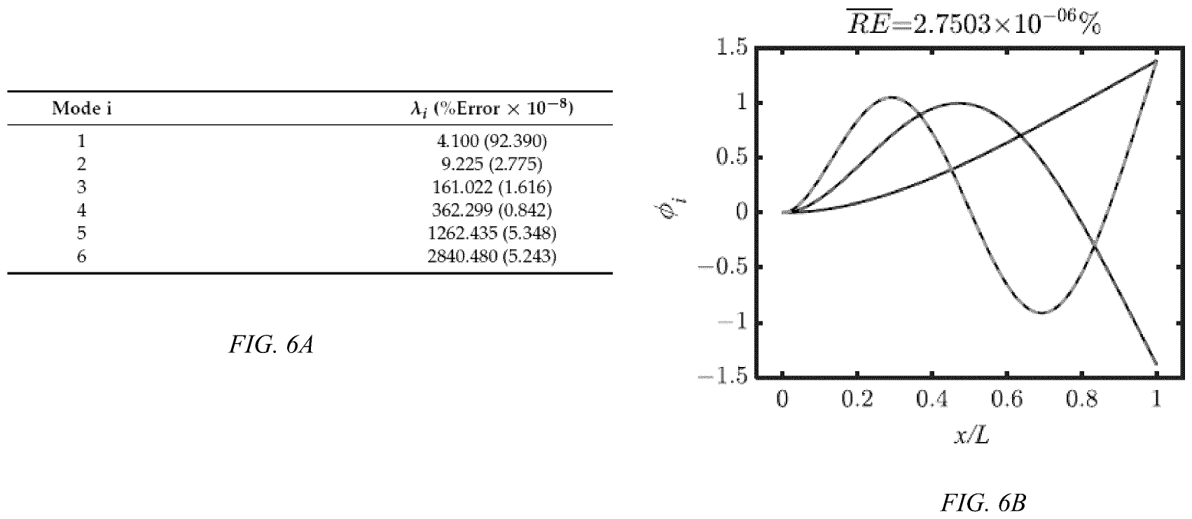

A cantilever beam was analyzed with properties L=5 m, E=68.9 GPa, ρ=2770 kgm⁻³, b=0.01 m and d=0.015 m. The characteristics of the cross-section area yielded distinct eigenvalues. Higher-order sensitivities with respect to the material (E, ρ) and geometrical (L) input design parameters were calculated. Three specific cases are presented, each representing an independent pass throughout the whole methodology. Third-order sensitivities with respect to the density ρ, third-order sensitivities with respect to the length of the beam L, and mixed third-order sensitivities with respect to the three parameters. This requires using tri-dual numbers with p=7 imaginary axes. In the first case, perturbations were added only to ρ on its three independent dual imaginary axes, becoming ρ=2770+ϵ₁+ϵ₂+ϵ₃. In the second case, perturbations were added only to L on its three independent dual imaginary axes, becoming L*=5+ϵ₁+ϵ₂+ϵ₃. In the third case, the perturbations were added to the three variables, these becoming ρ=2770+ϵ₁, E*=68×10⁹+ϵ₂ and L=5+ϵ₃. The axes not displayed here contain a value of zero for all cases. The table shown in FIG. 6A shows the results corresponding to the eigenvalues and FIG. 6B is a plot of the results for the eigenvectors, where the solid black lines represent the analytical solution, the red line represents the first and second mode, the magenta line represents the third and fourth modes, and the green line represents the fifth and sixth modes. Excellent agreement is found between the analytical solution and the numerical estimates, resulting in a maximum RE of 9.239×10-7% in the eigenvalues, and an average RE of 2.750×10-6% for the eigenvectors.

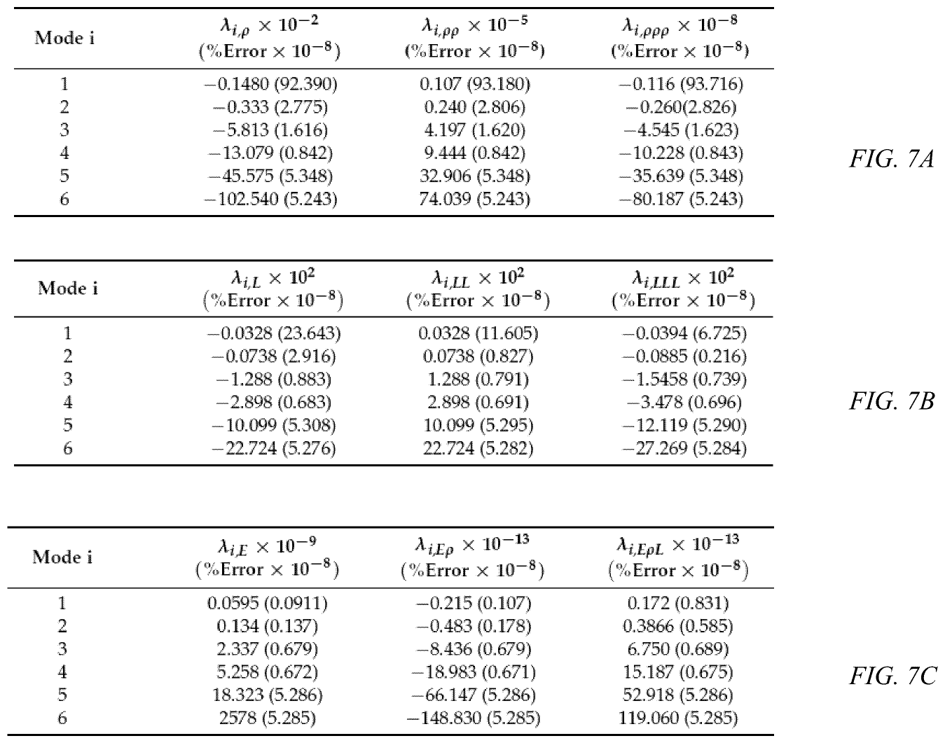

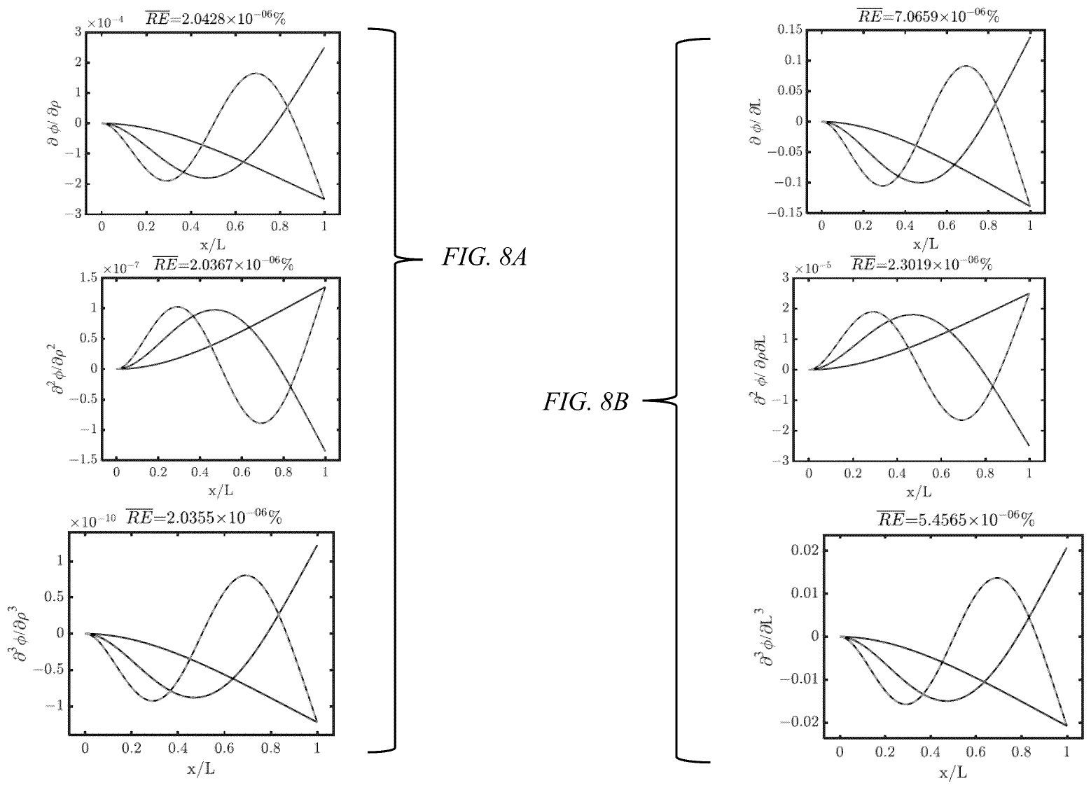

The tables shown in FIGS. 7A-7C and the plots in FIGS. 8A and 8B show the results of the sensitivity analysis of the structure. A good agreement is found with a maximum percentual error of 9.371 10-7% in the sensitivities of the eigenvalues and an average RE of 7.066 10-6% for the eigenvectors. These results preserve the same error magnitudes as the real solution, reflecting that HYPAD does not induce truncation nor subtraction cancellation errors. In addition, the same behavior is found for all the sensitivities regardless of the parameter of interest.

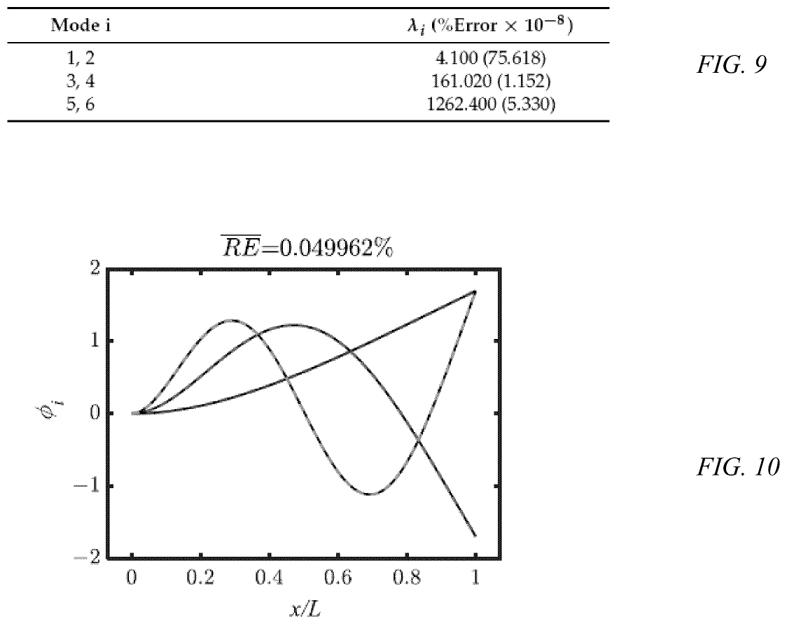

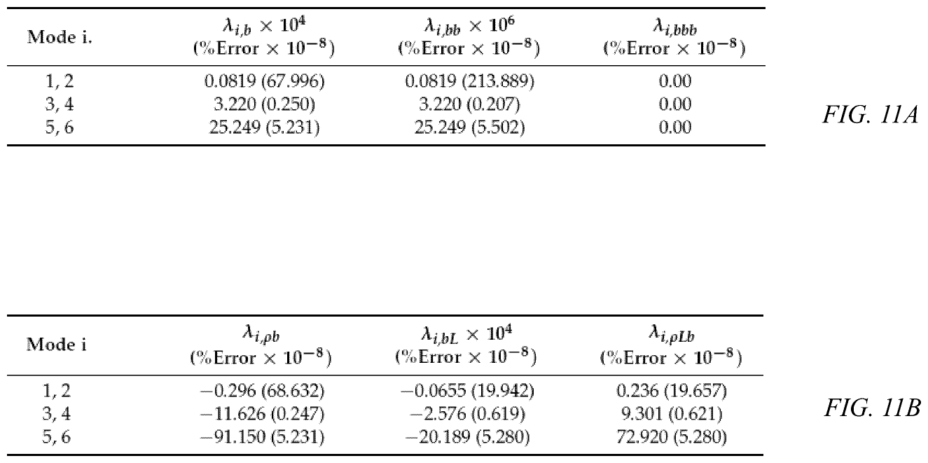

A model with symmetries about two rotational axes was studied to demonstrate our methodology when the system exhibits repeated eigenvalues. Here, a square cross-sectional area cantilever beam with L=5 m, E=68.9 GPa, ρ=2770 kgm⁻³, b=0.01 m, and b=d=0.01 m was considered. High-order sensitivities with respect to geometrical global and directional design variables were calculated. The first case corresponded to variables whose derivatives are also repeated because the symmetry of the system was not altered. On the other hand, directional design variables correspond to variables that affect the symmetry of the system; therefore, regardless of having repeated eigenvalues, their sensitivities are not repeated. The table shown in FIG. 9 shows the results for the eigenvalues of the system. The eigenvectors are shown in FIG. 10. As in the previous example, good agreement is found between the analytical solution and the numerical estimates, resulting in a maximum RE of 7.562×10-7% for the eigenvalues and an average of 0.0499% for the eigenvectors.

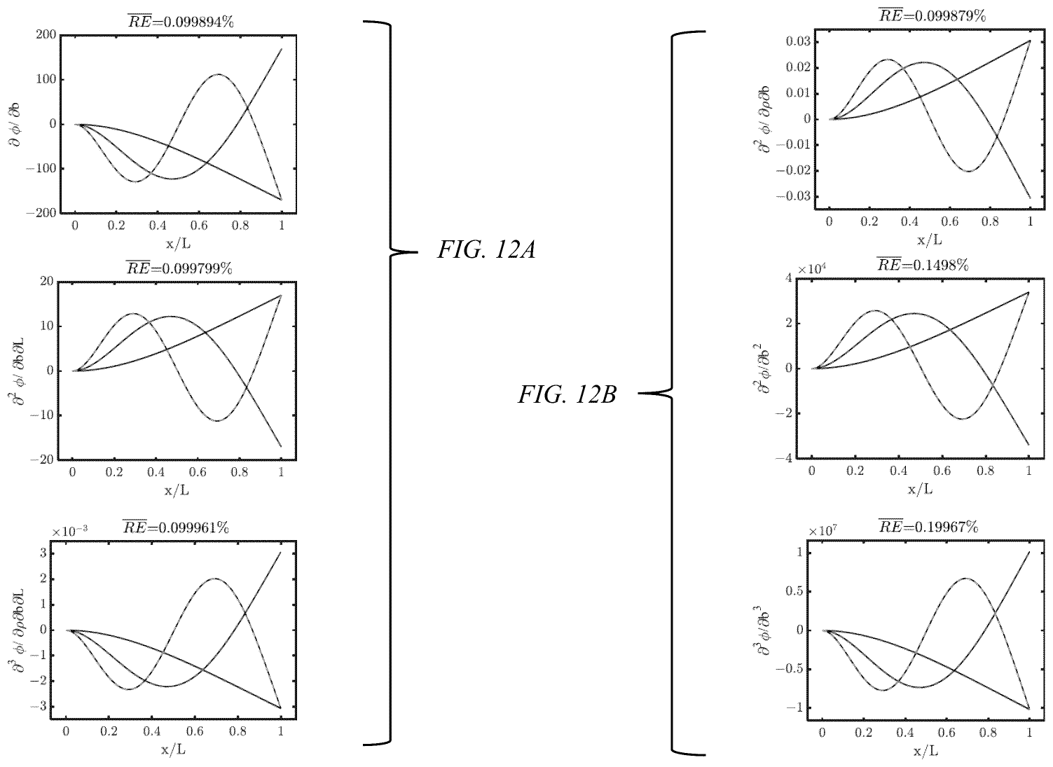

Sensitivities with respect to the global input design parameters were calculated. The material parameters, such as E and ρ, and the geometry parameters L and b were considered global design variables. Third-order sensitivities were calculated with respect to b. In this case, the variable b is perturbed the same amount in both directions (y and z) to achieve a global sensitivity (no breakage of symmetry). Thereby, b is perturbed to become b*=0.01+ϵ₁+ϵ₂+ϵ₃. In addition, third-order mixed partial derivatives were calculated with respect to p, L and b. In this case, perturbations must be added to the three variables, these becoming ρ*=2770|+ϵ₁, L*=5+ϵ₂, and b*=0.01+ϵ₃. The tables in FIGS. 11A and 11B show the results for the sensitivity analysis. Good agreement was found between the numerical results and the analytical solution, with a maximum RE of 2.139 10-6% for the eigenvalues. In this case, the same behavior of the error observed for the distinct eigenvalues case is present. These results validate, again, the inexistence of truncation and subtractive cancellation errors when differentiating using HYPAD with multidual numbers because the order of magnitude of the errors is preserved. FIGS. 12A and 12B show the results for the eigenvector sensitivities; a good agreement was found between the numerical results and the analytical solutions. The maximum average RE was found to be equal to 0.199%. In FIGS. 12A and 12B, solid black line represents the analytical solution, red line represents the first and second modes, magenta line represents the third and fourth modes, and green line represents the fifth and sixth modes.

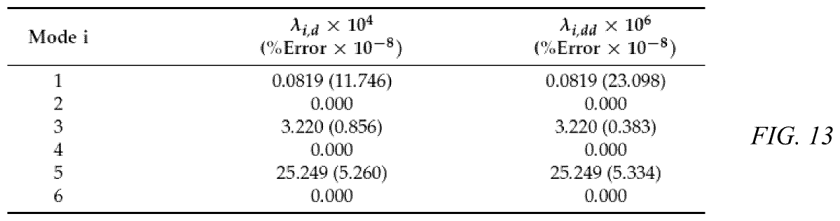

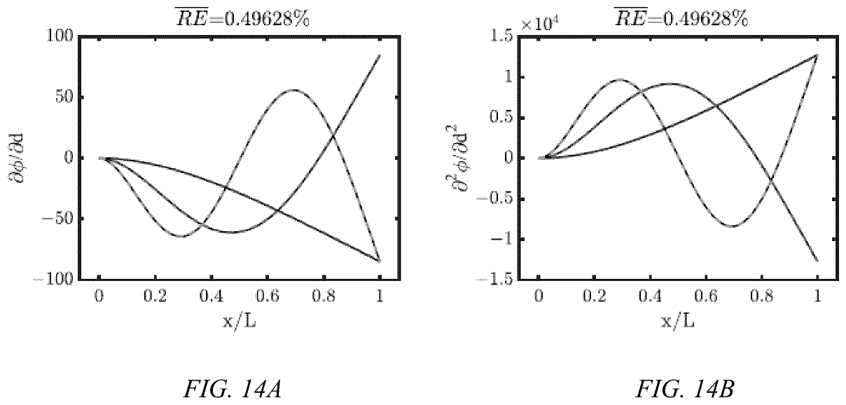

Sensitivities were calculated for the case of directional variables. In the present problem, the only directional input design variables are the cross-section parameter d and b, which are analogous. In this case, sensitivities were calculated with respect to d. This variable only affects the eigenvalues associated with Iy; thus, the sensitivities of some modes are zero, as seen in the table in FIG. 13. Here, the variable d is perturbed to become d*=0.01+ϵ₁+ϵ₂. This table shows the results for the sensitivity analysis. Good agreement was found between the numerical results and the analytical solution with a maximum relative error of 2.310×10-7% for the eigenvalues. FIGS. 14A and 14B show the results of the first- and second-order sensitivities of the eigenvectors reflecting good agreement when compared against the analytical solutions. The average RE of 0.496% was equal for both sensitivities. Although the sensitivities of the eigenvalues are distinct for each of the modes the sensitivities of the eigenvectors are equal for each pair of modes, and the methodology can recover this behavior. In FIGS. 14A and 14B, the solid black line represents the analytical solution, the red line represents the first and second modes, the magenta line represents the third and fourth modes, and the green line represents the fifth and sixth modes.

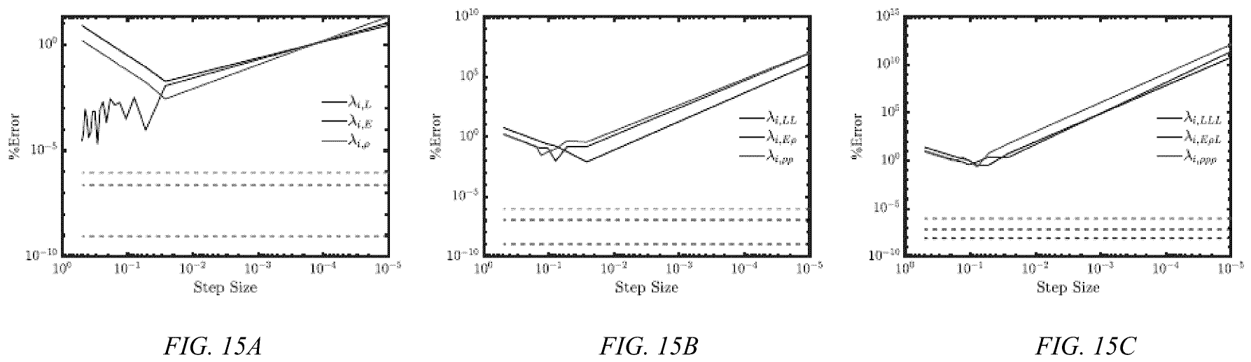

To demonstrate the capacity of the methodology to obtain highly accurate sensitivities, a convergence study of the perturbation step size for the case of distinct eigenvalues is performed and compared with FD. FIGS. 15A-15C show the variability in the relative error measurement for the derivatives of the eigenvalues corresponding to the first mode of vibration. The dashed line represents the results from HYPAD and the solid line the results from FD. FIG. 15A is the first-order derivatives, FIG. 15B is the second-order derivatives, and FIG. 15C is the third-order derivatives. Notably, the error for HYPAD remains constant regardless of the chosen step size for analysis. In contrast, the FD results exhibit high variability concerning the step size. Initially, the error decreases with the value of the step size up to an optimal point; then, as the step size keeps decreasing, the error starts to become dominated by the subtractive cancellation error, increasing its nominal value. Furthermore, the error with FD amplifies with the order of the derivative, resulting in errors with magnitudes of 1010. In the method proposed here, the error in any arbitrary-order sensitivity is in the same order as that of the real solution.

The methodology presented in this paper enables the calculation of arbitrary-order sensitivities of eigenvalues and eigenvectors using HYPAD. In this case, multidual numbers are used to compute the sensitivities with high accuracy. Although the focus of this methodology has been described herein on the analysis of structural dynamical systems, without loss of generality, the same methodology could be applied to other types of physics described by the GEP (e.g., Buckling analysis, principal component analysis (PCA), etc.).

The methodology was developed for the case of distinct and repeated eigenvalues and showed high accuracy for both types of problems when compared to repeated form analytical solutions in free vibration analysis of a cantilever beam. In the mathematical development of the equation to compute eigenvectors' sensitivities, it is stated that the matrix [Θ] can become singular in some cases when eigenvalues of high multiplicity (repeated, with several similar eigenvalues) are obtained. Despite this, no sign of singularity has been observed in the verification analysis performed in this work. However, a more in-depth analysis is needed in future to present a more in-depth conclusion.

The implementation of the current approach into commercial structural analysis software (i.e., Abaqus, Ansys, etc.) is left as future work. This could allow an increase in computational efficiency and enable the widespread use of the method for general structural systems regardless of the number of degrees of freedom. Although multidual numbers were used in this research to eliminate both truncation and subtractive cancellation errors, traditional complex numbers can be used if the user requires only the computation of first-order sensitivities, which are available in most of the commercial programming platforms. The only consideration needed is that the perturbation step size h should be small, say 10-10 times the variable of interest.

The proposed methodology is limited to analyzing the linear dynamics response of structural systems and does not consider the effect of material non-linearities, damping, loading or geometrical non-linearities. In addition, the computational cost, in terms of time and memory consumption, is acknowledged as a limitation of the proposed methodology. This limitation arises from the loss of sparsity and memory when evaluating the matrix of the coefficients in the equation shown in FIG. 1C. The issue becomes particularly challenging in systems with a large number of input design parameters, as it requires solving numerous systems of equations to assess all combinations of higher-order derivatives. To address this limitation, a solution that involves implementing a local residual formulation capable of computing sensitivities from expressions derived at the elemental level is used. This new formulation aims to preserve the sparsity of the matrix of coefficients. By adopting this strategy, significant improvements in the efficiency and scalability of the methodology is possible.

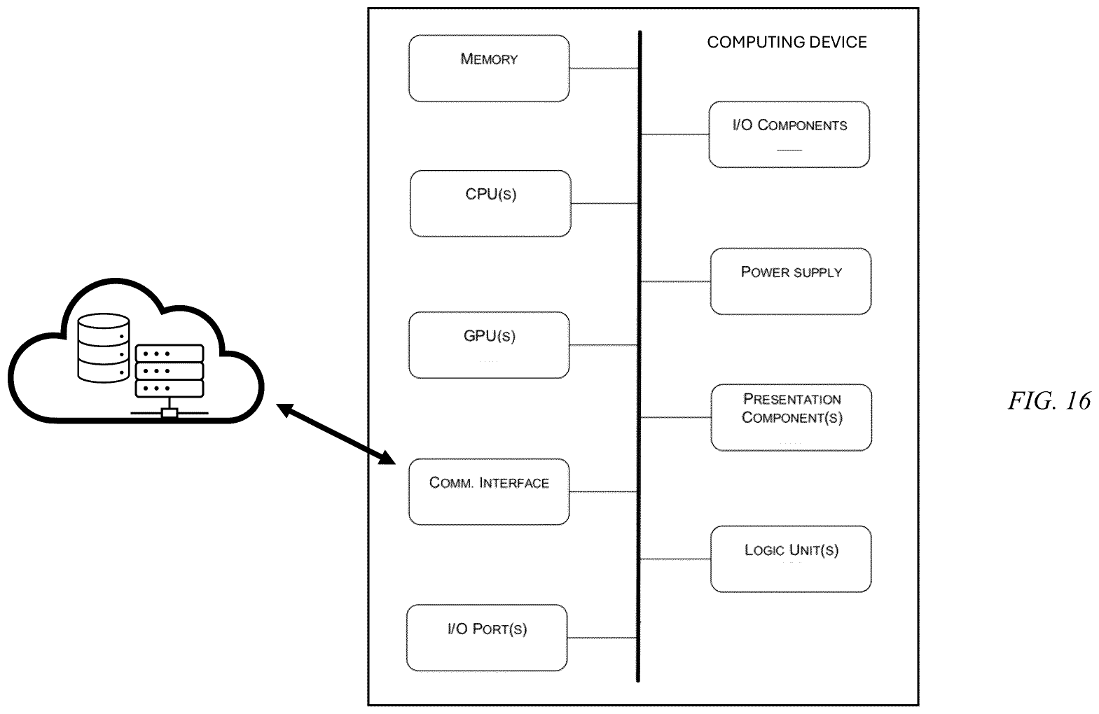

FIG. 16 is a simplified block diagram of an example computing device suitable for use in implementing some embodiments of the methodology described in the present disclosure. The methodology may be executed in the computing device or in one or more servers that reside in the cloud remote from the user(s). The computing device may include an interconnect system that directly or indirectly couples the following devices: memory, one or more central processing units (CPUs), one or more graphics processing units (GPUs), a communication interface, I/O ports, input/output components (e.g., touch screens, buttons, knobs), a power supply, one or more presentation components (e.g., display(s)), and one or more logic units. The computing device of FIG. 16 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” “augmented reality system,” and/or other device or system types, as all are contemplated within the scope of the computing device of FIG. 16.

The interconnect system may represent one or more links or busses, such as an address bus, a data bus, a control bus, or a combination thereof. Alternatively, the interconnect system may be a wireless communication system. The memory may include any of a variety of computer-readable media. The computer-readable media may be any available media that may be accessed by the computing device. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory may store computer-readable instructions (e.g., that represent a program(s) and/or a program element(s), such as an operating system.

Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computing device.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) may be configured to execute the computer-readable instructions to control one or more components of the computing device to perform one or more of the methods and/or processes described herein. In addition to or alternatively from the CPU(s), the GPU(s) may be configured to execute at least some of the computer-readable instructions to control one or more components of the computing device to perform one or more of the methods and/or processes described herein. In addition to or alternatively from the CPU(s) and/or the GPU(s), the logic unit(s) may be configured to execute at least some of the computer-readable instructions to control one or more components of the computing device to perform one or more of the methods and/or processes described herein. In embodiments, the CPU(s), the GPU(s), and/or the logic unit(s) may discretely or jointly perform any combination of the methods, processes and/or portions thereof. One or more of the logic units may be part of and/or integrated in one or more of the CPU(s) and/or the GPU(s) and/or one or more of the logic units may be discrete components or otherwise external to the CPU(s) and/or the GPU(s).

The communication interface may include one or more receivers, transmitters, and/or transceivers that enable the computing device to communicate with other computing devices via an electronic communication network, including wired and/or wireless communications. The computing device may communicate and transmit data to and from cloud-based servers and databases. The applications employing the methodology described in the present disclosure may be embodied in software code residing and executing in the computing device and/or in cloud-based servers and databases. The communication interface may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The I/O ports may enable the computing device to be logically coupled to other devices including the I/O components, the presentation component(s), and/or other components. Illustrative I/O components include microphone, mouse, keyboard, joystick, game pad, game controller, satellite dish, scanner, printer, wireless device, etc. The I/O components may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device. The computing device or the I/O components may include depth cameras, such as stereoscopic camera systems, infrared camera systems, RGB camera systems, touchscreen technology, and combinations of these, for gesture detection and recognition.

The presentation component(s) may include a display (e.g., a monitor, a touch screen, a television screen, a heads-up-display (HUD), other display types, or a combination thereof), speakers, and/or other presentation components. The presentation component(s) may receive data from other components (e.g., the GPU(s), the CPU(s), etc.), and output the data (e.g., as an image, video, sound, etc.).

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

What is claimed is:

1. A system for determining the arbitrary-order sensitivities of eigenvalues and eigenvectors of a structural system, comprising:
a user interface configured to receive data related to the structural system including model parameters {α₁, . . . , αⱼ} of the structural system and a maximum order of the derivative m to be computed;
a computing logical module configured to receive the data related to the structural system and:
compute system matrices [K] and [M] and their partial derivatives;
solve real-value generalized eigenvalue problem; and
determine sensitivities for the eigenvalues and the eigenvectors; and
the user interface being further configured to present an output of the sensitivities for the eigenvalues and the eigenvectors.

2. A method for determining the arbitrary-order sensitivities of eigenvalues and eigenvectors of a structural system, comprising:
receiving data related to the structural system including model parameters {α₁, . . . , αⱼ} of the structural system and a maximum order of the derivative m to be computed;
computing system matrices [K] and [M] and their partial derivatives;
solving real-value generalized eigenvalue problem;
determining sensitivities for the eigenvalues and the eigenvectors; and
presenting an output of the sensitivities for the eigenvalues and the eigenvectors.

3. A non-transitory computer-readable medium having encoded there on a method for determining the arbitrary-order sensitivities of eigenvalues and eigenvectors of a structural system, comprising:
receiving data related to the structural system including model parameters {α₁, . . . , αⱼ} of the structural system and a maximum order of the derivative m to be computed;
computing system matrices [K] and [M] and their partial derivatives;
solving real-value generalized eigenvalue problem;
determining sensitivities for the eigenvalues and the eigenvectors; and
presenting an output of the sensitivities for the eigenvalues and the eigenvectors.
